(19) United States
(12) Patent Application Publication
(10) Pub. No.: US 2018/0319017 A1
(43) Pub. Date: Nov. 8, 2018

(54) ROBOT AND CONTROL METHOD FOR ROBOT

(71) Applicant: SHARP KABUSHIKI KAISHA, Sakai City, Osaka (JP)

(72) Inventors: TAKAHIRO INOUE, Sakai City (JP); AKIRA MOTOMURA, Sakai City (JP)

(73) Assignee: SHARP KABUSHIKI KAISHA, Sakai City, Osaka (JP)

(21) Appl. No.: 15/766,784

(22) PCT Filed: Sep. 16, 2016
(86) PCT No.: PCT/JP2016/077358

§ 371 Date: Apr. 6, 2018

(30) Foreign Application Priority Data
Dec. 18, 2015 (JP) 2015-248040

(51) Int. Cl. B25J 13/08; B25J 9/16

(52) U.S. Cl. CPC B25J 13/089; B25J 13/081; B25J 9/1612; B25J 9/1602; B25J 9/1633

(57) ABSTRACT

Provided is a robot which allows a user to set a parameter, instead of separately providing any specific input section via which the parameter is set. A robot (1) includes (i) a right arm part, (ii) a servomotor, that is a right shoulder pitch, which is configured to drive the right arm part, (iii) an obtaining section (105) which is configured to obtain positional information on a position. of the right arm part which has been operated and (iv) a setting section (107) which is configured to set a value of a predetermined parameter to a value corresponding to the positional information that is obtained by the obtaining section (105).

### DESCRIPTION

### Technical Field

The present invention relates to a robot whose parameter setting is changeable, a method of controlling the robot, and a program for causing a computer to function as the robot.

### Background Art

There has been conventionally known a robot which has a plurality of movable parts such as two arms and/or two legs and which can take various postures and can walk with the two legs. There has been further known a robot which can communicate with a user, for example, talk with a user. As an example of these kinds of robot, Patent Literature 1 discloses robot phones with which a user can communicate such that the robot phones which are remote from each other are synchronized with each other in terms of, for example, their shapes, motions, and/or positions.

According to Patent Literature 1, a user causes a robot phone to wave its hand, which consequently causes another robot phone to wave its hand. This makes it possible to realize robots which can communicate with a user through gesture.

### CITATION LIST

### Patent Literature

### Patent Literature 1

Japanese Patent Application Publication Tokukai No. 2003-305670 (Publication date: Oct. 28, 2003)

### SUMMARY OF INVENTION

### Technical Problem

A user's operation with respect to a robot phone of Patent Literature 1 is absolutely for operating another robot phone. In a case where a user is allowed to set a predetermined parameter, such as speech volume, for a robot phone of the user, it is necessary to provide in advance the robot phone with some kind of input section (for example, an input key, an input button, a touch panel, etc.) via which the predetermined parameter is set.

Providing a robot with such an input section, however, sometimes impairs an appearance of the robot. In addition, causing a user to set a parameter via such an input section is likely to be troublesome for the user and impair a sense of togetherness between the user and the robot phone. It is therefore required to realize a robot which allows a user to set a parameter instead of separately providing such a specific input section.

The present invention has been made in order to address the problems. An object of the present invention is to provide (i) a robot which allows a user to set a parameter, instead of separately providing any specific input section via which the parameter is set, method of controlling the robot, and (iii) a program.

### Solution to Problem

In order to attain the object, a robot in accordance with an aspect of the present invention includes: a first movable part; a first driving section configured to drive the first movable part; a positional information obtaining section configured to obtain positional information on a position of the first movable part; and a setting section configured to set a value of a predetermined parameter to a value corresponding to the positional information that is obtained by the positional information obtaining section.

### Advantageous Effects of Invention

A robot in accordance with an aspect of the present invention allows a user to set a parameter, instead of separately providing any specific input section via which the parameter is set.

### BRIEF DESCRIPTION OF DRAWINGS

FIG. 1 is a block diagram illustrating how a robot of Embodiment 1 is configured.

(a) of FIG. 2 is a block diagram illustrating how an exterior of the robot of Embodiment 1 is configured. (b) of FIG. 2 is a view illustrating a skeleton of the robot illustrated in (a) of FIG. 2.

(a) of FIG. 3 is a table illustrating an example of a speech table. (b) of FIG. 3 is a view illustrating how to define an angle of a right shoulder pitch, in a case where the robot accepts an input from a user on a right arm part of the robot.

(a) of FIG. 4 is a table illustrating an example of an input posture table. (b) of FIG. 4 is a table illustrating another example of the input posture table.

(a) of FIG. 5 is a flow chart illustrating a flow of a parameter setting process carried out in a case where a method of controlling the robot of Embodiment 1 is employed. (b) through (d) of FIG. 5 are views each illustrating a posture of the robot in the flow chart illustrated in (a) of FIG. 5.

(a) of FIG. 6 is a flow chart illustrating a flow of a parameter setting process carried out in a case where a method of controlling a robot of Embodiment 2 is employed. (b), (d) and (f) of FIG. 6 are front views of the robot each illustrating an angle of a right shoulder pitch which angle corresponds to a corresponding current set value. (c), and (g) of FIG. 6 are side views of the robot illustrated in (b), (d) and (f) of FIG. 6, respectively.

(a) of FIG. 7 is a flow chart illustrating a flow of a parameter setting process carried out in a case where a method of controlling a robot of Embodiment 3 is employed. (b) of FIG. 7 is a front view of the robot illustrating a state where a current value of a set item is reflected in a joint part other than an input joint part, (c) of FIG. 7 is a side view of the robot illustrated in (b) of FIG. 7. (d) of is a front view of the robot illustrating a state where the robot illustrated in (c) of FIG. 7 is being operated by a user. (e) of FIG. 7 is a side view of the robot illustrated in (d) of FIG. 7.

### DESCRIPTION OF EMBODIMENTS

### Embodiment 1

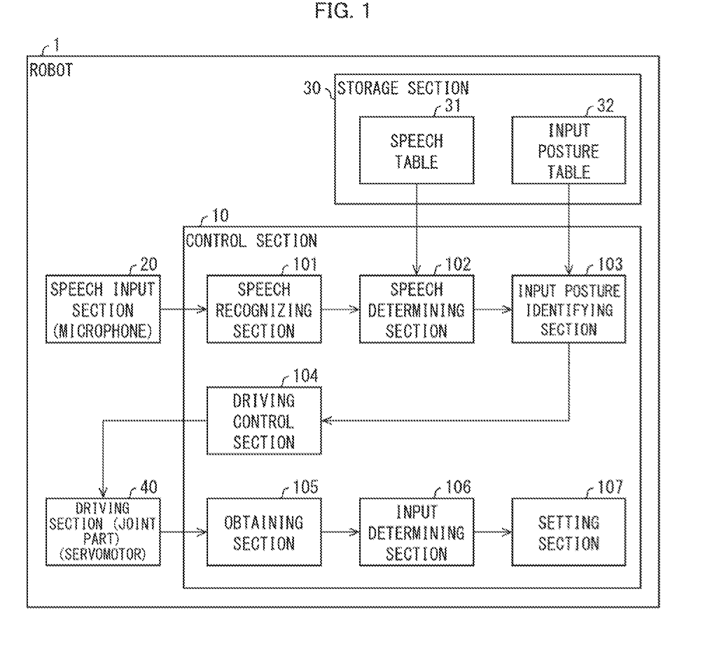

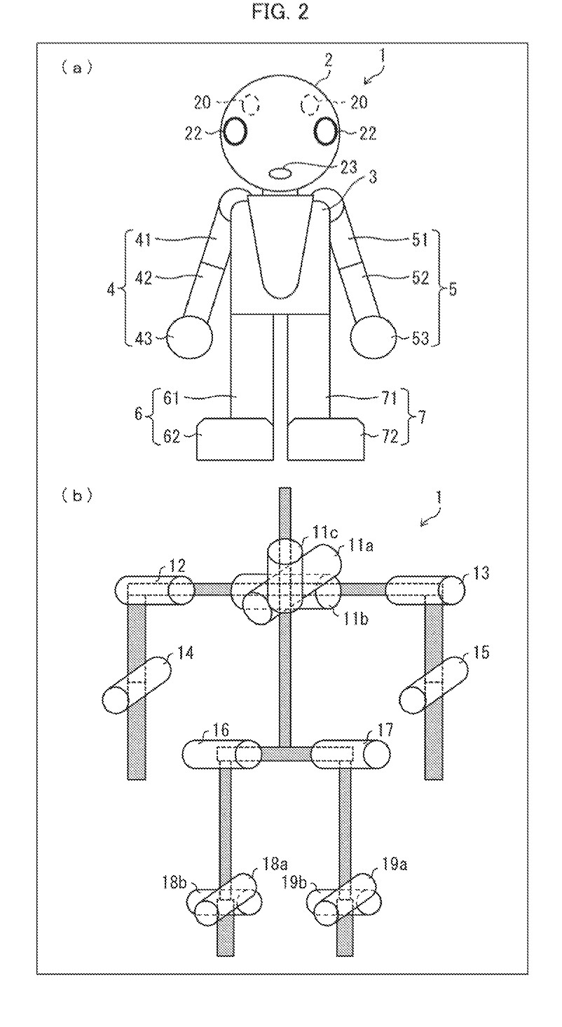

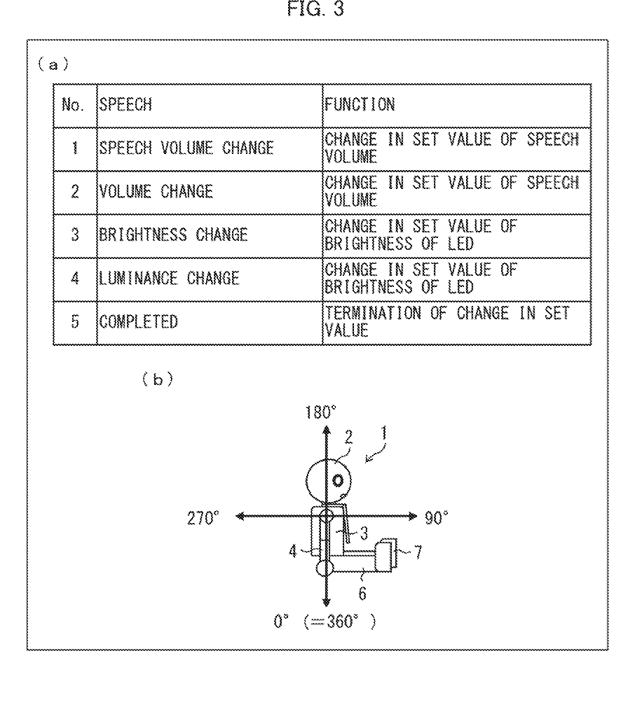

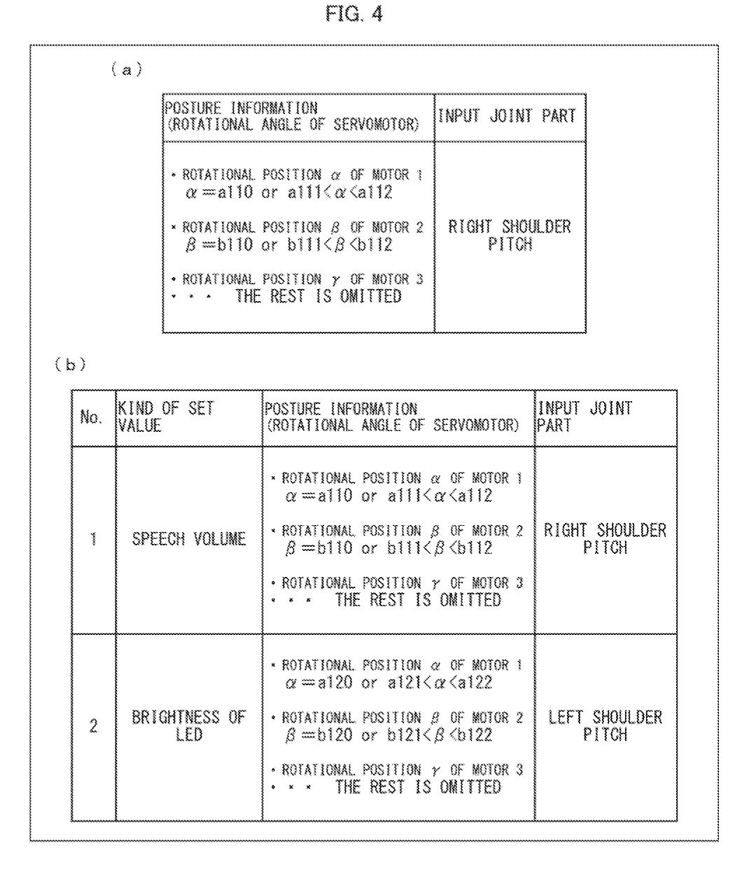

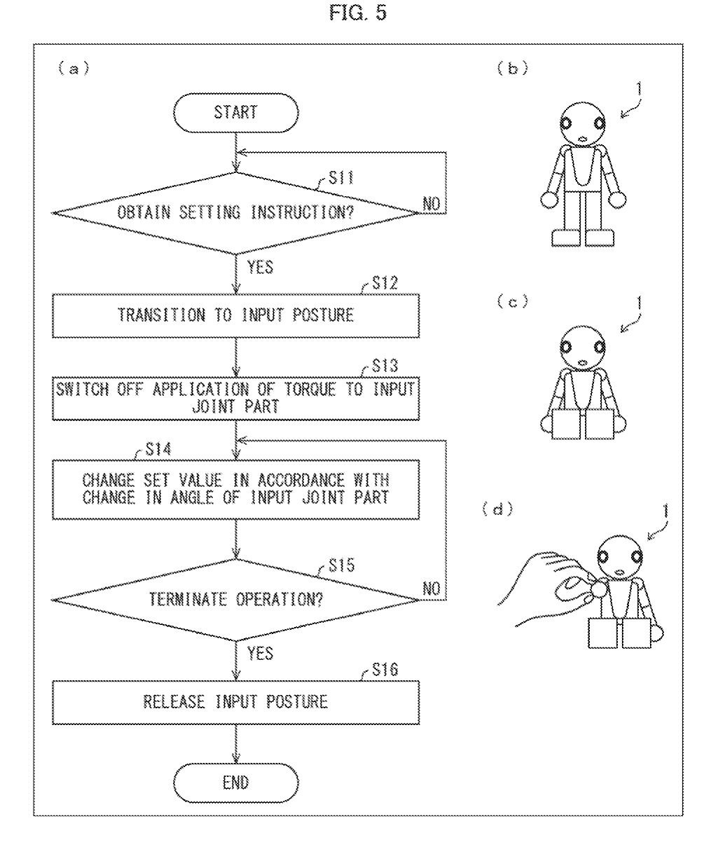

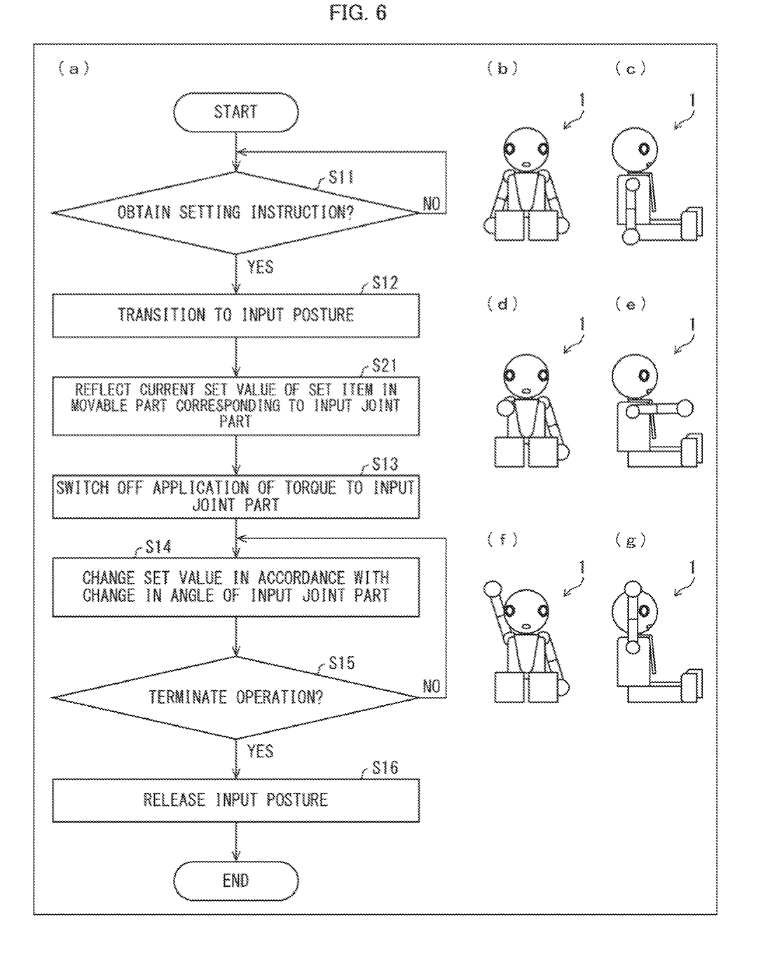

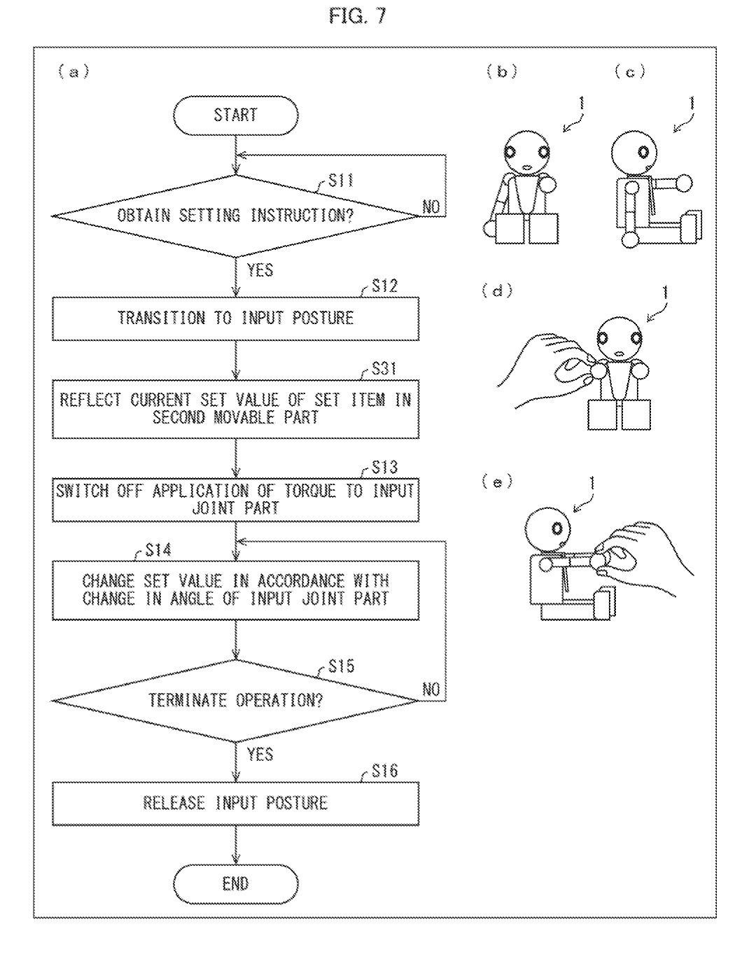

The following description will discuss Embodiment 1 in accordance with the present invention with reference to FIGS. 1 through 5.

(How Exterior of Robot 1 is Configured)

(a) of FIG. 2 is a block diagram illustrating how an exterior of a robot 1, which is a humanoid robot, in accordance with Embodiment 1 is configured. As illustrated in (a) of FIG. 2, the robot 1 includes a head part 2 (movable part), a trunk part 3, a right arm part 4 (movable part), a left arm part 5 (movable part, second movable part), a right leg part 6 (movable part), and a left leg part 7 (movable part). (a) of FIG. 2 illustrates how the robot 1 appears when viewed from a front side of the robot 1.

The head part 2 includes speech input sections 20 (microphones), Light Emitting Diodes (LEDs) 22, and a speaker 23. The LEDs 22 are provided so as to surround each eye of the robot 1. The speech input sections 20 are provided so as to correspond to respective ears of the robot, and the LEDs 22 are provided so as to correspond to the respective eyes of the robot.

The right arm part 4 is constituted by a right upper arm portion 41, a right forearm portion 42, and a right hand portion 43. The right upper arm portion 41, the right forearm portion 42, and the right hand portion 43 are provided in this order from one end (shoulder joint side) of the right arm part 4 toward the other end (wrist side) of the right arm part 4. The one end of the right arm part 4 is connected to a portion of the trunk part 3 which portion corresponds to a right shoulder of the trunk part 3. The left arm part 5 is constituted by a left upper arm portion 51, a left forearm portion 52, and a left hand portion 53. The left upper arm portion 51, the left forearm portion 52, and the left hand portion 53 are provided in this order from one end (shoulder joint side) of the left arm part 5 toward the other end (wrist side) of the left arm part 5. The one end of the left arm part 5 is connected to a portion of the trunk part which portion corresponds to a left shoulder of the trunk part 3.

The right leg part 6 is constituted by a right thigh portion 61 and a right foot portion 62. The right thigh portion 61 has (i) one end (groin side) which is connected to a portion of the trunk part 3 which portion corresponds to a waist of the trunk part 3 and (ii) the other end (ankle side) which is connected to the right foot portion 62. The left leg part 7 is constituted by a left thigh portion 71 and a left foot portion 72. The left thigh portion 71 has (i) one end (groin side) which is connected to a portion of the trunk part 3 which portion corresponds to the waist of the trunk part 3 and (ii) the other end (ankle side) which is connected to the left foot portion 72.

(Configuration of Skeleton of Robot 1)

(b) of FIG. 2 is a view illustrating how a skeleton of the robot in accordance with Embodiment 1 is configured. As illustrated in (b) of FIG. 2, in addition to components illustrated in FIG. 1, the robot 1 further includes a plurality of driving sections 40 (see FIG. 1) which individually drive the movable parts. Examples of the driving sections 40 encompass a neck roll 11a, a neck pitch 11b, a neck yaw 11c, a right shoulder pitch 12, a left shoulder pitch 13, a right elbow roll 14, a left elbow roll 15, a right crotch pitch 16, a left crotch pitch 17, a right ankle pitch 18b, a right ankle roll 18a, a left ankle pitch 19b, and a left ankle roll 19a. The neck roll 11a through the left ankle roll 19a are all realized by servomotors in Embodiment 1. For example, the term “neck roll 11a” intends to mean that a corresponding servomotor rotates and moves a corresponding movable part in a rolling direction. This also applies to the other members including the neck pitch 11b.

A control section 10 (later described, see FIG. 1) is configured to control the plurality of driving sections 40 to (i) rotate by respective designated angles or switch on/off applications of respective torques. This allows the robot 1 to conduct operations, such as a change in posture and walking. Specifically, ones of the plurality of driving sections 40, whose angles are adjustable, will be hereinafter referred to as joint parts. Note that a state, in which a driving section 40 is controlled to switch on application of torque, refers to a state in which a force (driving force) is transmittable from the driving section 40 to a corresponding movable part, whereas a state, in which a driving section 40 is controlled to switch off application of torque, refers to a state in which transmitting of the force from the driving section 40 to a corresponding movable part is stopped.

The neck roll 11a, the neck pitch 11b, and the neck yaw 11c are provided in a place corresponding to a place where a neck of the robot 1 is located. The control section 10 controls the neck roll 11a, the neck pitch 11b, and the neck yaw 11c, so that a motion of the head part 2 of the robot 1 is controlled.

The right shoulder pitch 12 is provided in a place corresponding to a place where a right shoulder of the robot 1 is located. The control section 10 controls the right shoulder pitch 12, so that a motion of the whole right arm part 4 of the robot 1 is controlled. The left shoulder pitch 13 is provided in a place corresponding to a place There a left shoulder of the robot 1 is located. The control section 10 controls the left shoulder pitch 13, so that a motion of the whole left arm part 5 of the robot 1 is controlled.

The right elbow roll 14 is provided in a place corresponding to a place where a right elbow of the robot 1 is located. The control section 10 controls the right elbow roll 14, so that a motion of the right forearm portion 42 and a motion of the right hand portion 43 of the robot 1 are controlled. The left elbow roll 15 is provided in a place corresponding to a place where a left elbow of the robot 1 is located. The control section 10 controls the left elbow roll 15, so that a motion of the left forearm portion 52 and a motion of the left hand portion 53 of the robot 1 are controlled.

The right crotch pitch 16 is provided in a place corresponding to a place where a right crotch of the robot 1 is located. The control section 10 controls the right crotch pitch 16, so that a motion of the whole right leg part 6 of the robot 1 is controlled. The left crotch pitch 17 is provided in a place corresponding to a place where a left crotch of the robot 1 is located. The control section 10 controls the left crotch pitch 17, so that a motion of the whole left leg part 7 of the robot 1 is controlled.

The right ankle pitch 18b and the right ankle roll 18a are provided in a place corresponding to a place where a right ankle of the robot 1 is located. The control section 10 controls the right ankle pitch 18b and the right ankle roll 18a, so that a motion of the right foot portion 62 of the robot 1 is controlled. The left ankle pitch 19b and the left ankle roll 19a. are provided in a place corresponding to a place where a left ankle of the robot 1 is located. The control section 10 controls the left ankle pitch 19b and the left ankle roll 19a, so that a motion of the left foot portion 72 of the robot 1 is controlled.

The plurality of driving sections 40 can each notify the control section 10 of a status such as an angle at predetermined time intervals. Such notifications of the statuses can be sent even in a case where applications of torques to the respective servomotors are switched off. This allows for detection of motions of the movable parts which motions are made by a user. Upon receipt of notifications of the respective statuses, the control section 10 can recognize angles of the respective servomotors.

(Configuration of Robot 1)

FIG. 1 is a block diagram illustrating how the robot 1 is configured. As illustrated in FIG. 1, the robot includes the control section 10, the speech input sections 20 (setting instruction obtaining sections), a storage section 30, and the plurality of driving sections 40. The plurality of driving sections 40 have already been described with reference to (b) of FIG. 2.

The control section 10 is configured to centrally control motions and processes of the robot 1. How the control section 10 is specifically configured will be later described. The speech input sections 20 (obtaining sections) are each a device for obtaining a speech inputted by a user to the control section 10. In Embodiment 1, the speech input sections 20 are realized by microphones. The storage section 30 is a storage medium which stores therein various pieces of information based on which the control section 10 carries out processes. Specific examples of the storage section 30 include a hard disk and a flash memory. The storage section 30 stores, for example, a speech table 31 and an input posture table 32. Note that the speech table 31 and the input posture table 32 will be later described.

(Configuration of Control Section 10)

The control section 10 includes a speech recognizing section 101, a speech determining section 102, an input posture identifying section 103, a driving control section 104 (stop section), an obtaining section 105 (positional information obtaining section), an input determining section 106, and a setting section 107.

The speech recognizing section 101 recognizes a speech inputted to the speech input sections 20. The speech determining section 102 determines whether the speech recognized by the speech recognizing section 101 is a predetermined speech included in the speech table 31 of the storage section 30.

The input posture identifying section 103 identifies an input posture and an input joint part of the robot 1 with reference to the input posture table 32. The input posture is a posture of the robot 1 during which posture the robot 1 accepts an input from a user. The input joint part is a joint part which is used during inputting of the user. The driving control section 104 controls the plurality of driving sections 40 so that the robot 1 takes the input posture identified by the input posture identifying section 103.

The obtaining section 105 obtains positional information on a position of each of the movable parts which has been operated by a user. According to Embodiment 1, the obtaining section 105 obtains, as the positional information, angular information on an angle of each of the movable parts. The input determining section 106 determines, on the basis of the positional information, an input value given by the user. The setting section 107 sets a value of a predetermined parameter in accordance with the input value. Examples of the predetermined parameter include (i) the speech volume of a speech outputted from the speaker 23 and each brightness of the LEDs 22. A set value of the parameter is neither positional information nor an input value itself but can be a value which (i) is calculated (converted) from the positional information or the input value and (ii) is different from the positional information or the input value.

According to Embodiment 1, the control section 10 is a CPU. The storage section 30 stores therein program for causing the control section 10 to function as each of the above-described sections, such as the obtaining section 105 and the setting section 107. That is, a computer including the control section 10 and the storage section 30 is incorporated in the robot 1.

(Speech Table 31 and Input Posture Table 32)

(a) of FIG. 3 is a table illustrating an example of the speech table 31. As illustrated in the table, the speech table 31 is a data table indicating a correspondence between (i) respective speeches recognized by the speech recognizing section 101 and respective functions executed in the robot 1. For example, in a case where the speech recognizing section 101 recognizes a speech “speech volume change” or “volume change,” the speech determining section 102 determines that the speech intends to mean that a change in set value of a current volume should be initiated. In a case where the speech recognizing section 101 recognizes a speech “brightness change” or “luminance change,” the speech determining section 102 determines that the speech intends to mean that a change in set value of a current brightness of the LEDs 22 should be initiated. In a case where the speech recognizing section 101 recognizes a speech “completed,” the speech determining section 102 determines that the speech intends to mean a speech which notifies the robot 1 of termination of a change in set value(s).

of FIG. 4 is a table illustrating an example of the input posture table 32. As illustrated in the table, the input posture table 32 can be a data table indicating a correspondence between respective pieces of postural information and respective input joint parts. The pieces of postural information indicate rotational angles of the servomotors in the respective plurality of driving sections 40. Based on pieces of postural information, the plurality of driving sections 40 are controlled so that the robot 1 takes an input posture. The input posture table 32 of (a) of FIG. 4 illustrates an example in which the input posture is a sitting posture of the robot 1. The input posture table 32 also illustrates an example in which the right shoulder pitch 12 is set as the input joint part.

All of the plurality of driving sections 40 are not necessarily controlled in a case where the robot changes its posture to the input posture. At least one of the plurality of driving sections 40 merely needs to be controlled in accordance with the kind of input posture. That is, on an occasion when the posture of the robot changes to the input posture, at least one of the movable parts is driven to a position corresponding to the input posture.

(b) of FIG. 4 is a table illustrating another example of the input posture table 32. As is illustrated in the table, the input posture table 32 can be a data table indicating a correspondence between (i) the kind of set value to be changed, the postural information and (iii) the input joint part. According to the input posture table 32 illustrated in (b) of FIG. 4, the input posture and the input joint part vary depending on the kind of set value to be changed. Specifically, in a case where setting of the speech volume of the speaker 23 is changed, the robot 1 takes a sitting posture, and the right shoulder pitch 12 is set as the input joint part. Meanwhile, in a case where setting of the brightness of the LEDs 22 is changed, the robot 1 takes an upright posture, and the left shoulder pitch 13 is set as the input joint part.

In the input posture table 32 illustrated in (b) of FIG. 4, a correspondence is carried out such that both the input posture and the input joint part each vary depending on the kind of set value. Meanwhile, a correspondence can be alternatively carried out such that the input posture does not vary but the input joint part merely varies, depending on the kind of set value to be changed, and vice versa.

(Flow of Parameter Setting Process)

(a) of FIG. 5 is a flow chart illustrating a flow of a parameter setting process carried out in a case where a method of controlling the robot 1 of Embodiment 1 is employed. The robot 1, in an initial state, stands by for receiving a setting instruction (S11). Note here that the setting instruction intends to mean a speech associated with a change in set value in the speech table 31. In the example illustrated in (a) of FIG. 3, speeches No. 1 through No. 4 correspond to respective setting instructions.

In a case where the speech recognizing section 101 recognizes that a speech has been inputted to the speech input sections 20, the speech determining section 102 determines whether the speech is related to a setting instruction. In a case where the speech is not related to the setting instructions (NO in S11), the robot stands by for a speech to be inputted again to the speech input sections 20.

In a case where the speech is related to a setting instruction (YES in S11), the input posture identifying section 103 identifies an input posture and an input joint part with reference to the input posture table 32. The driving control section 104 controls a target driving section 40 to drive so that the robot 1 undergoes a transition to the input posture (S12). The driving control section 104 further switches off application of a torque to the input joint part (S13).

In a case where a user operates a movable part which corresponds to the input joint part, the obtaining section 105 obtains positional information from the input joint part (positional information obtaining step). The obtaining section 105 understands a posture of the robot 1 based on the positional information, and then notifies the input determining section 106 of the positional information thus obtained. The positional information can be information on a position itself or an amount of change in position. The input determining section 106 determines, based on the positional information, an input value given by the user. The setting section 107 sets the parameter on the basis of the input value (setting step) (S14).

Until a speech for terminating the change in set value is inputted to the speech input sections 20 (NO in S15), the robot 1 keeps (i) taking the input posture and a state where application of a torque to the input joint part is being switched off. In a case where the speech determining section 102 determines that the speech for terminating the change in the set value is inputted to the speech input sections 20 (YES in S15), the input posture identifying section 103 instructs the driving control section 104 to release the input posture. The driving control section 104, in turn, controls application of the torque to the input joint part to be switched on so as to release the input posture. After the input posture is released, the robot 1 can take a predetermined posture or can keep the posture which was taken by the robot 1 which obtained the setting instruction in S11. Alternatively, the robot 1 can merely switch on application of the torque to the input joint part without changing the input posture of S15.

The following description will discuss in detail an operational example of the robot 1. In a case where a user inputs a speech “speech volume change” to the speech input sections 20 in S11, the speech recognizing section 101 recognizes the speech. Then, the speech determining section 102 determines, with reference to the speech table 31, whether the speech is a setting instruction. In the speech table 31, the speech “speech volume change” and a function “change in set value of speech volume” are associated with each other (see (a) of FIG. 3). This causes the speech determining section 102 to determine that the setting instruction has been inputted (YES in S11).

Just for reference, in a case where a user inputs a speech “Good morning” to the speech input sections 20 in S11, the speech table 31 does not include any set value changing function which corresponds to the speech “Good morning” (see (a) of FIG. 3). This causes the speech determining section 102 to determine that no setting instruction has been inputted (NO in S11).

The following description will discuss S12. In S12, the input posture table illustrated in (b) of FIG. 4 is employed as the input posture table 32. The input posture identifying section 103 identifies a sitting posture as an input posture based on postural information corresponding to “speech volume” in the input posture table 32, and identifies the right shoulder pitch 12 as an input joint part. Then, the driving control section 104 controls a target driving section 40 to drive so that the robot 1 takes the input posture (S12). The driving control section 104 further switches off application of a torque to the right shoulder pitch 12 that is the input joint part. This allows the right shoulder pitch 12 to accept an input from a user (S13).

The obtaining section 105 obtains, via the right shoulder pitch 12, the input from the user, i.e., angular information of the right arm part 4. The input determining section 106 finds, from the angular information, a change in angle of the right shoulder pitch 12, and then determines an input value given by the user. Then, the setting section 107 changes a set value of the speech volume in accordance with the input value (S14).

Thereafter, in a case where a user inputs a speech “completed” to the speech input sections 20, the speech recognizing section 101 recognizes the speech, and then the speech determining section 102 determines the speech. In the speech table 31, the speech “completed” and “termination of change in set value” are associated with each other. This causes the speech determining section 102 to determine that the user has terminated his/her operation (YES in S15). The input posture identifying section 103 notifies the driving control section 104 of releasing the input posture of the robot 1. The driving control section 104 controls the target driving section 40 to release the input posture (S16). The robot 1 of Embodiment 1 is set so that, in a case where the input posture is released, the robot 1 is set to return to the posture which the robot 1 takes in S11.

Note that, after it is determined in S15 that a user has terminated his/her operation, the setting section 107 can change a set value of the speech volume of the speaker 23 in accordance with an input value, instead of changing the set value in S14 every time the user operates the right arm part 4 (every time an angle of the right arm part 4 is changed). That is, the setting section 107 can a ge (set) once the speech volume in accordance with the angle of the right arm part 4 which angle the user determines immediately before the user terminates his/her operation.

(Posture Change)

(b) through (d) of FIG. 5 are views each illustrating a posture of the robot 1 in the flow chart illustrated in of FIG. 5. In S11, the robot 1 takes a given posture, for example, an upright posture illustrated in of FIG. 5. As has been described, in S12, the robot 1 takes an input posture, for example, a sitting posture illustrated in (c) of FIG. 5.

In S14, a user's operation causes the right arm part 4 of the robot 1 to change an angle of the right arm part 4 of the robot 1 (see (d) of FIG. 5). After S14, a change in parameter setting is completed in S15, and the input posture is released in S16, so that the robot 1 returns to the upright posture illustrated in (b) of FIG. 5.

(Relationship Between Driving Scope and Speech Volume to be Set)

The following description will discuss, in more detail, an operation of the input determining section 106. In a case where a user operates a movable part of the robot 1 so as to change parameter setting of the robot 1, it is necessary to associate (i) how much the user operates the movable part with (ii) an amount of change in set value. It is the input determining section 106 that associates the above (i) with the above (ii).

(b) of FIG. 3 is a view illustrating how to define an angle of the right shoulder pitch 12, in a case where the right shoulder pitch 12 of the robot 1 is an input joint part. The following description assumes that (i) the angle of the right shoulder pitch 12 is 0°, in a case where the right arm part 4 is lowered perpendicularly with respect to a plane on which the robot 1 sits (see (b) of FIG. 3), (ii) the angle of the right shoulder pitch 12 is 90°, in a case where the right arm part 4 is horizontally extended ahead of the robot 1, (iii) the angle of the right shoulder pitch 12 is 180°, in a case where the right arm part 4 is raised perpendicularly with respect to the plane, and (iv) the angle of the right shoulder pitch 12 is 270°, in a case where the right arm part 4 is horizontally extended behind the robot 1.

The following description will discuss an example case where (i) the right shoulder pitch 12, that is the input joint part, accepts an input from a user over 360° and (ii) the speech volume of the speaker 23 can be set on a scale of level “0” to level “9.” In this case, the input determining section 106 divides a movable range of the right shoulder pitch 12 into 10 (ten) movable subranges equal in number to the ten levels of the speech volume so as to associate the ten movable subranges with the respective ten levels of the speech volume. More specifically, 0°≤θ<36° is associated with speech volume “0,” 36°≤θ<72° is associated with speech volume “1,” and 324°≤θ<360° is associated with speech volume “9,” where θ indicates the angle of the right shoulder pitch 12.

The following description will discuss another example case where the movable range of the right shoulder pitch 12, that is the input joint part, is limited. Note that, even in a case where the right shoulder pitch 12 can ordinarily rotate by 360°, it is not always appropriate that the right shoulder pitch 12 accepts an input from a user over 360°. For example, in a case where the angle of the right shoulder pitch 12 is around 0° as illustrated in (b) of FIG. 3, the right arm part 4 is likely to contact the ground. Meanwhile, in a case where a user operates the right arm part 4 in front of the robot 1, it is more difficult for the user to operate the right arm part 4 behind the robot 1 (at or around 270° as illustrated in (b) of FIG. 3) than in front of the robot 1 (at or around 90° as illustrated in (b) of FIG. 3).

In view of the circumstances, the movable range of the right shoulder pitch 12 set during the normal times (autonomous state) can differ from that set during which the right shoulder pitch 12 accepts a user's input (heteronomous state). For example, it is assumed that the movable range of the right shoulder pitch 12 is set to a range from 0° to 360° in the autonomous state, whereas a range from 30° to 150° in the heteronomous state. Under the assumption, the input determining section 106 divides an angle of 120°, ranging from 30° to 150°, into ten subranges equal in number to the ten levels of the speech volume. This eliminates the probability of the right arm part 4 contacting the ground even in a case where a user operates the right arm part 4 and (the necessity of the user operating the right arm part 4 to an angle at which it is difficult for the user to operate the right arm part 4.

In the robot 1, a plurality of joint parts can be employed as the input joint part. This is effective particularly in a case There the number of levels of a set value is large. For example, the speech volume of the speaker 23 can be set on a scale of level “0” to level “99.” In this case, (i) both the right shoulder pitch 12 and the left shoulder pitch 13 serve as respective joint parts each of which accepts an input from a use the first digit of the number of levels is set by use of the left shoulder pitch 13 and (iii) the second digit of the number of levels is set by use of the right shoulder pitch 12. Each of the joint parts is not limited to a specific movable range, and therefore can be, for example, a movable range from 0° to 360°, a movable range from 30° to 150°, or a further movable range.

For example, in a case where the speech volume of the speaker 23 is set to “43,” the first digit of “43” is set to “3” by use of the left shoulder pitch 13, and the second digit is set to “4” by use of the right shoulder pitch 12. Similarly, in a case where the speech volume of the speaker 23 is set to “99,” the first digit and the second digit are set to “9” by use of the left shoulder pitch 13 and the right shoulder pitch 12, respectively. By thus employing the plurality of joint parts as the respective input joint parts, it is possible to easily input and change a set value even in a case where the number of levels of the set value is large.

In order to notify a user that a set value is changed by a user's input, the setting section 107 can alternatively instruct the driving control section 104, at a tinning when the set value is changed, to temporarily switch on application of a torque to a joint part which has accepted the input so that the joint part is stopped. Alternatively, the user can be notified of the set value through the speaker 23 at the above timing.

For example, at a timing when the speech volume of the speaker 23 is increased from “1” to “2,” (i) the joint part can be stopped, the speaker 23 can output a speech ‘the set value is now “2”’, or (iii) both the above (i) and (ii). Similarly, at a timing when the speech volume of the speaker 23 is decreased from “2” to “1,” (i) the joint part can be stopped, (ii) the speaker 23 can output a speech ‘the set value is now “1,”’ or (iii) both the above (i) and (ii).

In order to show a user an angular range of a joint part within which angular range the user can operate the joint part, the driving control section 104 can control the joint part to be driven within the angular range, (i) after the robot 1 undergoes a transition to an input posture but before the driving control section 104 switches off application of a torque to the joint part. For example, in a case where the right shoulder pitch 12 accepts an input from a user within an angular range from 30° to 150°, the driving control section 104 can (i) control the robot 1 to undergo a transition to an input posture, (ii) control the right shoulder pitch 12 to move from 30° to 150°, and then (iii) control the robot 1 to be at an initial position of the input posture.

With the configuration of the robot 1, a user can set a parameter, instead of separately providing any specific input section via which the parameter is set. Hence, the robot 1 can become a robot which does not include the input section which impairs design of the robot.

Embodiment 1 has described an example where the right shoulder pitch 12 and/or the left shoulder pitch serve(s) as an input joint part(s). Any driving section(s) 40 can alternatively be employed as an input joint part(s). Moreover, the robot I of Embodiment 1 is not limited to a specific one, provided that a robot has a joint part. Examples of such a robot encompass an animal robot, an insect robot, and the humanoid robot. Note that, other than the above robots, a robot can be employed as the robot 1 of Embodiment 1, provided that the robot has an angularly adjustable part. Examples of the robot 1 of Embodiment 1 encompass a robot in the shape of a plant that has, for example, an angularly adjustable flower, stem, and/or branch.

Note that the robot 1 is not limited to a specific one, provided that a robot has a size and a shape which does not impair the design of the robot 1. Examples of such a robot encompass a robot which is provided with a display section such as a liquid crystal display (LCD) or an input section. Examples of such an input section include an input key/input button and a touch panel integrated with a display section.

As has been described in each of the flow charts, a change in set value of the robot 1 is initiated and terminated in S11 and S15 based on the speech inputted into the speech input sections 20. Embodiment 1 is not limited as such. The change in set value of the robot 1 can alternatively be initiated and terminated based on an input other than the speech. For example, the robot 1 can initiate and terminate a change in set value based on an input to the input section. Even in such a case, the change in set value is made by operating a movable part of the robot 1, as has been described.

### Embodiment 2

The following description will discuss Embodiment 2 of the present invention with reference to FIG. 6. Identical reference signs are given to members identical to those of Embodiment 1, and detailed descriptions of such members are omitted in Embodiment 2.

(a) of FIG. 6 is a flow chart illustrating a flow of a parameter setting process carried out in a case where a method of controlling a robot 1 of Embodiment 2 is employed. (b), (d) and (f) of FIG. 6 are front views of the robot 1 each illustrating an angle of a right shoulder pitch 12 which angle corresponds to a corresponding current set value. (c), (e) and (g) of FIG. 6 are side views of the robot 1 illustrated in (b), (d) arid (f) of FIG. 6, respectively.

The flow chart illustrated in (a) of FIG. 6 is different from that illustrated in (a) of FIG. 5, in that the flow chart illustrated in (a) of FIG. 6 further includes S2 1 between S12 and S13. After the robot undergoes a transition to an input posture in S12, a driving control section 104 controls an input joint part so that a current set value of a set item is reflected in a movable part corresponding to the input joint part of the robot 1 (S21). The current set value is stored in, for example, a storage section 30.

For example, in a case where (i) the input joint part is the right shoulder pitch 12, a speech volume can be set on a scale of level “0” to level “10”, (iii) the right shoulder pitch 12 has a movable range from 0° to 180°, and (iv) the speech volume is “0,” a right arm part 4 is in a state of being lowered vertically (see (b) and (c) of FIG. 6). Meanwhile, in a case where the speech volume is “10,” the right arm part 4 is being raised vertically (see (f) and (g) of FIG. 6). In a case where the current set value of the speech volume is “5,” the driving control section 104 controls the right shoulder pitch 12 so that the right arm part 4 protrudes from the front of the robot 1 (see (d) and (e) of FIG. 6).

By thus reflecting the current set value of the set item in the input joint part of the robot 1, it is possible to notify a user of a current set value of an item which is to be changed. The user therefore can easily conduct an input operation for making a change in setting.

### Embodiment 3

The following description will discuss Embodiment 3 of the present invention with reference to FIG. 7. Identical reference signs are given to members identical to those of Embodiment 1 or 2, and detailed descriptions of such members are omitted in Embodiment 3.

(a) of FIG. 7 is a flow chart illustrating a flow of a parameter setting process carried out in a case where a method of controlling a robot 1 of Embodiment 3 is employed. (b) of FIG. 7 is a front view of the robot illustrating a state where a current value of a set item is reflected in a joint part other than an input joint part. (c) of FIG. 7 is a side view of the robot 1 illustrated in (b) of FIG. 7. (d) of FIG. 7 is a front view of the robot 1 illustrating a state where the robot 1 illustrated in (c) of FIG. 7 is being operated by a user. (e) of FIG. 7 is a side view of the robot 1 illustrated in (d) of FIG. 7.

The flow chart illustrated in (a) of FIG. 7 is different from that illustrated in (a) of FIG. 5, in that the flow chart illustrated in of FIG. 7 further includes S31 between S12 and S13. After the robot undergoes a transition to an input posture in S12, a driving control section 104 reflects a current set value of the set item in a second movable part (S31). The second movable part is a given movable part other than a movable part which corresponds to the input joint part. The second movable part can always be the same. Alternatively, second movable parts corresponding to respective kinds of set value can be determined in an input posture table 32.

Similar to Embodiment 2, for example, in a case where (i) the input joint part is a right shoulder pitch 12, a speech volume can be set on a scale of level “0” to level “10”, (iii) the second movable part is a left arm part 5, and (iv) the speech volume has a current set value of “5”, the driving control section 104 controls a left shoulder pitch 13, that is a second driving section, so that the left arm part 5 protrudes from the front of the robot 1 (see (b) through (e) of FIG. 7). In this case, similar to Embodiment 1, a right arm part 4 can be in a state of being lowered (see (b) and (c) of FIG. 7). Alternatively, similar to Embodiment 2, the current set value can be reflected in the right arm part 4 (see (d) and (e) of FIG. 7).

By thus reflecting the current set value of the set item in the joint part other than the input joint part of the robot 1, a user can change the current set value while confirming the current set value. The user can therefore easily conduct an input operation for making a change in setting.

The following description will discuss a case where the robot 1 of Embodiment 3 is a robot phone. Note that the robot phone is assumed to include an LCD.

Upon receipt of a request for (i) controlling of a speech volume or a luminance of the LCD or (ii) an analogue input from an application such as a game, the driving control section 104 controls the robot 1 to undergo a transition to an input posture. The input posture varies in accordance with the number of values which is required to input. In a case where the speech volume or the luminance of the LCD is adjusted, a value which is required to input is a single value. The robot 1 therefore undergoes a transition to an input posture for the single value (for example, a sitting posture as illustrated in (c) of FIG. 5). Meanwhile, in a case where the robot 1 is employed as if the robot 1 were a joy stick for a computer game, a value which is required to input is two values. The robot 1 therefore undergoes a transition to an input posture for the two values (for example, an upright posture as illustrated in (b) of FIG. 5). In a case where the robot 1 undergoes a transition to an input posture, an angle of a joint part (a position of a movable part), which accepts the input, can be changed in accordance with a current set value of an item which has been required to input. When the input is terminated, the robot 1 is notified of the termination, by a speech or via, for example, a touch panel provided so as to overlap with the LCD. Upon receipt of the notification, the robot 1 undergoes a transition to an initial posture.

[Variation 1]

The following description will discuss two examples in each of which set values of respective set items are simultaneously changed. According to one of the two examples, a speech table 31 includes a setting instruction for simultaneously setting a plurality of set items. For example, a correspondence between a speech “batch setting change” and a function “speech volume/brightness of LEDs” is stored in addition to the correspondence between “speech” and “function” (see (a) of FIG. 3). In a case where a speech recognizing section 101 recognizes the speech “batch setting change,” an obtaining section 105 obtains (i) an amount of change in angle of an input joint part corresponding to a speech volume and an amount of change in angle of an input joint part corresponding to the brightness of LEDs. Parameter setting is thus changed.

According to the other of the two examples, a plurality of setting instructions are redundantly accepted. For example, in a case where a setting instruction “speech volume change” is obtained and then (ii) a speech “brightness change” is obtained instead of terminating a change in set value of a speech volume, it is sufficient that the set value of the speech volume and a set value of the brightness of LEDs are simultaneously changed.

This makes it possible to easily change set values of respective set items. In this case, it is preferable that an input joint part corresponding to the speech volume and an input joint part corresponding to the brightness of the LEDs differ from each other. For example, the input joint part corresponding to the speech volume can be a right shoulder pitch 12, and the input joint part corresponding to the brightness of the LEDs can be a left shoulder pitch 13.

[Variation 2]

A single set item, such as “speech volume” or “brightness of LEDs 22,” has a single set value. The following description will discuss a case where a single set item has a plurality of set values. It is possible to easily change each of the plurality of set values, for example, in a case where (i) a set item “color of LEDs 22” has three set values (i.e., an intensity of R (red), an intensity of G (green), and an intensity of blue (B)) and the intensity of R, the intensity of G, and the intensity of B can be set by use of a right shoulder pitch 12, a left shoulder pitch 13, and a right crotch pitch 16, respectively, namely, in a case where (a) a single set item has a plurality of set values and (b) joint parts, which vary from set value to set value, are employed as respective input joint parts.

[Software Implementation Example]

A control block (particularly a control section 10) of a robot 1 can be realized by a logic circuit (hardware) provided in an integrated circuit (IC chip) or the like or can be alternatively realized by software as executed by a central processing unit (CPU). In the latter case, the robot 1 includes: a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

[Recap]

A robot (1) in accordance with Aspect 1. of the present invention is arranged to include: a first movable part (for example, a right arm part 4 or a left arm part 5); a first driving section (40) configured to drive the first movable part; a positional information obtaining section (105) configured to set a value of a predetermined parameter to a value corresponding to the positional information that is obtained by the positional information obtaining section; and a setting section (107) configured to set, as a value of a predetermined parameter, a value corresponding to the positional information that is obtained by the positional information obtaining section.

According to the arrangement, the first movable part is a part, such as an arm part or a leg part, of the robot which part is driven by the first driving section. A user's operation with respect to the first movable part causes a value of a parameter such as a speech volume or an amount of light to be set to a value corresponding to a position of the first movable part which has been operated. The robot therefore does not need to include any specific input section via which the parameter is set.

As such, the robot in accordance with the aspect of the present invention allows a user to set a parameter, instead of separately providing any specific input section via which the parameter is set.

In Aspect 2 of the present invention, a robot is arranged such that, in Aspect 1 of the present invention, the robot further includes a stop section configured to stop transmitting a force from the first driving section to the first movable part, and the positional information obtaining section being configured to obtain the positional information, in a case where the first movable part is operated in a state where transmitting of the force from the first driving section to the first movable part is being stopped by the stop section.

According to the arrangement, in a case where a first movable part is operated, transmitting of a force from a corresponding first driving section to the first movable part is being stopped. This makes it possible to surely operate the first movable part.

In Aspect 3 of the present invention, a robot is arranged such that, in Aspect 1 or 2 of the present invention, the positional information obtaining section obtains, as the positional information, angular information on an angle of the first movable part.

According to the arrangement, a user can input a set value of a parameter to the robot by operating the first movable part so as to change the angle of the first movable part.

In Aspect 4 of the present invention, a robot is arranged such that, in any of Aspects 1 through 3 of the present invention, the robot further includes: a plurality of movable parts including the first movable part which are different from each other; a plurality of driving sections including the first driving section which individually drive the plurality of movable parts; a setting instruction obtaining section (speech input section 20) configured to obtain a setting instruction for setting the parameter; and a driving control section configured to, in a case where the setting instruction obtaining section obtains the setting instruction, control at least one of the plurality of driving sections to drive at least one of the plurality of movable parts to a position corresponding to a posture of the robot in which posture an operation with respect to the at least one of the plurality of movable parts is accepted.

According to the arrangement, by visually recognizing a change in posture of the robot which has obtained the setting instruction, a user can know that the robot has shifted to a mode for allowing the user to input a set value of the parameter by operating the at least one of the plurality of movable parts. This allows the user to start operating, at an appropriate timing, the at least one of the plurality of movable parts via which the parameter is set.

In Aspect 5 of the present invention, a robot is arranged such that, in any of Aspects 1 through 3 of the present invention, the robot further includes: a first setting instruction obtaining section configured to obtain a setting instruction for setting the parameter; and a first driving control section configured to, in a case where the first setting instruction obtaining section obtains the setting instruction, control the first driving section to drive the first movable part to a position corresponding to a current value of the parameter.

According to the arrangement, a user can know the current value of the parameter to be set, by visually recognizing a position of the first movable part of the robot to which the user has given the setting instruction. This allows the user to operate the first movable part on the basis of a current position of the first movable part via which the parameter is set. The user can therefore easily operate the first movable part which is used to input a desired set value.

In Aspect 6 of the present invention, a robot is arranged such that, in any of Aspects 1 through 3 of the present invention, the robot further includes: a second movable part (left arm part 5) different from the first movable part; a second driving section (left shoulder pitch 13), different from the first driving section, which drives the second movable part; a second setting instruction obtaining section configured to obtain a setting instruction for setting the parameter; and a second driving control section configured to, in a case where the second setting instruction obtaining section obtains the setting instruction, control the second driving section to drive the second movable part to a position corresponding to a current value of the parameter.

According to the arrangement, a user can know a current value of the parameter to be set, by visually recognizing a position of the second movable part of the robot to which the user has given the setting instruction. This allows the user to operate the second movable part via which the parameter is set while understanding the current value of the parameter on the basis of the position of the second movable part. The user can therefore easily operate the second movable part which is used to input a desired set value.

A method of controlling a robot in accordance with Aspect 7 of the present invention is arranged to be a method of controlling a robot which includes a movable part and a driving section which drives the movable part, the method including the steps of: (i) obtaining positional information on a position of the movable part; and (ii) setting a value of a predetermined parameter to a value corresponding to the positional information obtained in the step (i).

The above arrangement brings about an effect identical to that brought about by the robot in accordance with Aspect 1 of the present invention.

The robot in accordance with each aspect of the present invention can be realized by a computer. In this case, the present invention encompasses (i) a control program for the robot which control program causes a computer to operate as each section (software element) of the robot so that the robot can be realized by the computer and (ii) a computer-readable storage medium in which the control program is stored.

The present invention is not limited to the description of the embodiments, but may be altered by a skilled person in the art within the scope of the claims. An embodiment derived from a proper combination of technical means disclosed in different embodiments is also encompassed in the technical scope of the present invention. Furthermore, by a combination of technical means disclosed in different embodiments, a new technical feature can be derived.

### REFERENCE SIGNS LIST

1: robot
4: right arm part (movable part)
5: left arm part (movable part, second movable part)
12: right shoulder pitch (driving section)
13: left shoulder pitch (second driving se
20: speech input section (setting instruction obtaining section)
40: driving section
104: driving control section (stop section)
105: obtaining section (positional information obtaining section)
107: setting section

1. A robot, comprising:
a first movable part;
a first driving section configured to drive the first movable part;
a positional information obtaining section configured to obtain positional information on a position of the first movable part; and
a setting section configured to set a value of a predetermined parameter to a value corresponding to the positional information that is obtained by the positional information obtaining section.

2. A robot as set forth in claim 1, further comprising a stop section configured to stop transmitting a force from the first driving section to the first movable part, and
the positional information obtaining section being configured to obtain the positional information, in a case where the first movable part is operated in a state where transmitting of the force from the first driving section to the first movable part is being stopped by the stop section.

3. The robot as set forth in claim 1, wherein the positional information obtaining section obtains, as the positional information, angular information on an angle of the first movable part.

4. The robot as set forth in claim 1, further comprising:
a plurality of movable parts including the first movable part which are different from each other;
a plurality of driving sections including the first driving section which individually drive the plurality of movable parts;
a setting instruction obtaining section configured to obtain a setting instruction for setting the parameter; and
a driving control section configured to, in a case where the setting instruction obtaining section obtains the setting instruction, control at least one of the plurality of driving sections to drive at least one of the plurality of movable parts to a position corresponding to a posture of the robot in which posture an operation with respect to the at least one of the plurality of movable parts is accepted.

5. A robot as set forth in claim 1, further comprising:
a first setting instruction obtaining section configured to obtain a setting instruction for setting the parameter; and
a first driving control section configured to, in a case where the first setting instruction obtaining section obtains the setting instruction, control the first driving section to drive the first movable part to a position corresponding to a current value of the parameter.

6. The robot as set forth in claim 1, further comprising:
a second movable part different from the first movable part;
a second driving section, different from the first driving section, which drives the second movable part;
a second setting instruction obtaining section configured to obtain a setting instruction for setting the parameter; and
a second driving control section configured to, in a case where the second setting instruction obtaining section obtains the setting instruction, control the second driving section to drive the second movable part to a position corresponding to a current value of the parameter.

7. A method of controlling a robot which includes a movable part and a driving section which drives the movable part,
the method comprising the steps of:
(i) obtaining positional information on a position of the movable part; and
(ii) setting a value of a predetermined parameter to a value corresponding to the positional information obtained in the step (i).

8. (canceled)
